(19) United States
(12) Patent Application Publication
(10) Pub. No.: US 2026/0138118 A1
(43) Pub. Date: May 21, 2026

(54) SILICA GEL DESICCANT TABLET

(71) Applicant: Manish Jain, Pune (IN)

(72) Inventors: Manish Jain, Pune (IN); Vivek Kumar Jha, Pune (IN)

(73) Assignee: Manish Jain, Pune (IN)

(21) Appl. No.: 19/121,409

(22) PCT Filed: May 16, 2023
(86) PCT No.: PCT/IN2023/050461

§ 371 Date: Apr. 15, 2025

(30) Foreign Application Priority Data
Oct. 21, 2022 (IN) 20221060447

(51) Int. Cl. B01J 20/10; B01J 20/28; B01J 20/30

(52) U.S. Cl. CPC B01J 20/103; B01J 20/2803; B01J 20/28047; B01J 20/3007; B01J 20/3042

(57) ABSTRACT

The present invention discloses a silica gel desiccant tablet and a process of preparation of the silica gel desiccant tablet. The silica gel desiccant tablet includes 60 to 65% of silica gel powder having a particle size between 200 to 400 mesh; 25 to 30% of powdered bentonite clay; 1.5 to 2% of magnesium stearate; 5 to 10% of water-soluble polymer; and 200 ml distilled water. The tablets have a diameter of 9 mm, 11 mm, 12 mm and 16 mm; and a height of 5 mm. The tablets are obtained in a mechanically stable form without compromising the moisture adsorption performance. The silica gel desiccant tablets show maximum moisture adsorption capacity of 22.8% at 25° C. and 80% relative humidity after 24 hours of exposure in confined volume.

### FIELD OF THE INVENTION

The present invention relates to silica gel desiccant composition, and more particularly to silica gel desiccant tablets.

### BACKGROUND OF THE INVENTION

The shelf life of drugs, nutraceuticals and foodstuffs available in the packaged form is affected by a variety of factors including microbial or fungal contamination. In the drug, nutraceutical and food industry, there is always a requirement for desiccants and dehumidifiers to keep the packaging of the product free from moisture. The most common desiccants used in the market include silica gel, activated carbon, calcium chloride, activated alumina, montmorillonite clay and different types of molecular sieves.

The desiccants available in the market are mostly in the form of granules, beads or pellets enclosed in pouches and canisters. The patent application WO2009026755A1 to Dai Xinhua discloses a silica desiccant having silica powder and starch. The patent application WO1997032663A1 to Hekal Ihab M describe desiccant entrained polymers having desiccant located within the interior portion of the polymer structure; and method of preparing such polymers. The Japanese patent application JPH0347513A to Peetaa Hentsureru and others discloses desiccant tablets coated with a coating material that does not decrease the drying rate and drying capacity.

Thus, the formation of a desiccant in a shaped form requires coating with a polymeric agent and high temperature treatment. The desiccants available is granular form have the disadvantage of dust spillage and subsequent contamination of the drugs and nutraceuticals. There is a need of a desiccant in a shaped form that is mechanically stable without compromising the moisture adsorption performance.

### SUMMARY OF THE INVENTION

The present invention describes a silica gel desiccant tablet having 60 to 65% silica gel powder having a particle size between 200 to 400 mesh; 25 to 30% powdered bentonite clay having a particle size between 200 to 400 mesh; 1.5 to 2% magnesium stearate; 5 to 10% water soluble polymer; and 200 ml distilled water.

The silica gel desiccant tablet specifically includes 70 gm of powdered silica gel having particle size between 200 to 400 mesh; 30 gm of bentonite clay having a particle size between 200 to 400 mesh; 2 gm of magnesium stearate; 10 gm of polyvinyl alcohol, and 300 ml of distilled water.

The present invention further describes a process for preparation of silica gel desiccant tablet including mixing 60 to 65% of silica gel powder having particle size between 200 to 400 mesh thoroughly with 25 to 30% of powdered bentonite clay having a particle size between 200 to 400 mesh, and 1.5 to 2% of magnesium stearate to form a silica gel mixture; followed by dissolving 5 to 10% of water-soluble polymer in 200 ml of distilled water and heating at first predefined temperature for a first predefined time; cooling the polymer solution to a second predefined temperature for a second predefined time; mixing the polymer solution to the above silica gel mixture under constant stirring; adding 200 ml of distilled water to the mixture to form a homogenous slurry; drying the slurry at a third predefined temperature at a third predefined time to obtain a dried mixture containing 20% moisture; pressing the dried mixture at a predefined pressure to form tablets; and further heating the tablets to remove remaining moisture.

In this process of the present invention, the water-soluble polymer is dissolved in 200 ml of distilled water and heated at 60° C. for 1 hour; the polymer solution is cooled to room temperature for 1.5 hours; the slurry is dried at 110° C. for 2 hours to obtain a dried mixture containing 20% moisture; and the dried mixture is pressed at a pressure between 12 to 17 KN to form tablets.

The process for preparation of silica gel desiccant tablet for unit quantities of silica gel desiccant composition includes mixing 70 g of powdered silica gel having particle size between 200 to 400 mesh homogeneously with 30 g of bentonite clay having a particle size between 200 to 400 mesh, and 2 g of magnesium stearate in a laboratory blender to form a silica gel mixture; dissolving 10 g of polyvinyl alcohol in 100 ml of distilled water and heating at 60° C. for 1 hour; cooling the polymer solution at room temperature for 1.5 hours; adding the PVA solution to the silica gel mixture with continuous stirring; adding 200 ml of distilled water to the mixture to form a homogenous slurry; drying the slurry at 110° C. for 2 hours to obtain a semi dried mixture containing 20% moisture and passing the mixture through 18 mesh sieves; pressing the dried mixture in a tablet press with pressure of 15 KN to form tablets; and heating the tablets further to 110° C. with the ramp rate of 40-70° C. for 1 hour, followed by holding at 70° C. for 30 mins; then at a ramp rate of 70-110° C. for 1 hour and holding at 110° C. for 30 mins.

The silica gel desiccant tablets have maximum moisture adsorption capacity of 22.8% at 25° C. and 80% relative humidity after 24 hours of exposure in confined volume.

### DETAILED DESCRIPTION OF THE INVENTION

The present invention relates to a silica gel desiccant composition compressed in the form of a tablet.

The foregoing objects of the present invention are accomplished and the problems and shortcomings associated with the prior art, techniques and approaches are overcome by the present invention as described below in the preferred embodiments.

All materials used herein were commercially purchased as described herein or prepared from commercially purchased materials as described herein.

Although specific terms are used in the following description for sake of clarity, these terms are intended to refer only to particular structure of the invention selected for illustration in the drawings and are not intended to define or limit the scope of the invention.

References in the specification to “preferred embodiment” means that a particular feature, structure, characteristic, or function described in detail thereby omitting known constructions and functions for clear description of the present invention.

In accordance with the present invention, the silica gel desiccant tablet includes:
a) silica gel powder;
b) powdered bentonite clay;
c) magnesium stearate;
d) binding agent; and
e) distilled water.

In accordance with a preferred embodiment, the silica gel desiccant tablet of the present invention includes:
a) 60 to 65% of silica gel powder;
b) 25 to 30% of powdered bentonite clay;
c) 1.5 to 2% of magnesium stearate;
d) 5 to 10% of water-soluble polymer; and
e) 200 ml distilled water.

In this preferred embodiment, the silica gel powder has a particle size between 200 to 400 mesh; more preferably between 250 to 320 mesh.

The particle size of the silica gel powder enables uniform compression of tablets. Further, decrease in particle size result in decrease in the porosity and eventually the moisture adsorption performance of the final product. The particle size is selected in a way to keep the porosity of silica gel intact during the synthesis steps and in the final product.

In the preferred embodiment, the binding agent is selected from water soluble polymers including poly vinyl alcohol (PVA), polyethylene glycol (PEG), polyvinyl pyrrolidone (PVP), polyacrylic acid (PAA), polyacrylamides, polyoxazoline, polyphosphates and polyphosphazenes.

Poly vinyl alcohol (PVA) is selected as a binding agent due to ease of polymer dissolution and due to its ability to enable strong bonding of silica gel particles.

In the preferred embodiment, the powdered bentonite clay is of the same particle size as that of silica gel, i.e., a particle size between 200 to 400 mesh.

Now, a preferred process of preparation of the silica gel desiccant tablet in accordance with the present invention is disclosed. The process includes:
a) mixing 60 to 65% of silica gel powder having particle size between 200 to 400 mesh thoroughly with about 25 to 30% of powdered bentonite clay having particle size between 200 to 400 mesh, and 1.5 to 2% of magnesium stearate to form a silica gel mixture;
b) dissolving 5 to 10% of water-soluble polymer in 200 ml of distilled water and heating at first predefined temperature for a first predefined time;
c) cooling the polymer solution to a second predefined temperature for a second predefined time;
d) mixing the polymer solution to the above silica gel mixture under constant stirring;
e) adding 200 ml of distilled water to the mixture to form a homogenous slurry;
f) drying the slurry at a third predefined temperature at a third predefined time to obtain a dried mixture containing about 20% moisture;
g) pressing the dried mixture at a predefined pressure to form tablets; and
h) further heating the tablets to remove remaining moisture.

The detailed steps of the above-mentioned process for preparing the silica gel desiccant tablet are described herein:
In step b), the first predefined temperature is 60° C. and the first predefined time is 1 hour.
In step c), the second predefined temperature is room temperature and second predefined time is 1.5 hours.
In step f), the third predefined temperature is 110° C. and third predefined time is 2 hours.
In step g), the predefined pressure is between 12 to 17 KN.

In accordance with the present invention, the heating of the tablets removes any remaining moisture and provides maximum mechanical strength to the tablets. The ingredients silica gel, bentonite clay and polyvinyl alcohol are mixed homogenously for optimal performance. The moisture content of 20% inside the tablets during tableting allows the removal of moisture from within the pores of tablets. Also, the development of channels inside the tablet during moisture removal ensures available sites for moisture adsorption with dried tablets.

Further, the tablets with various dimensions are prepared as per the required adsorption performance. The tablets have diameter of 9 mm, 11 mm, 12 mm and 16 mm; and a height between 3.5 mm to 6.5 mm.

### EXAMPLES

Only a few examples and implementations are disclosed. Variations, modifications, and enhancements to the described examples and implementations and other implementations can be made based on what is disclosed.

Examples are set forth herein below and are illustrative of different amounts and types of reactants and reaction conditions that can be utilized in practicing the disclosure. It will be apparent, however, that the disclosure can be practiced with other amounts and types of reactants and reaction conditions than those used in the examples, and the resulting devices various different properties and uses in accordance with the disclosure above and as pointed out hereinafter.

### Example 1: Silica Gel Desiccant Tablet with Silica Gel Desiccant Composition in Unit Quantities

The silica gel desiccant tablet includes:
1) 70 gm of powdered silica gel having particle size between 200 to 400 mesh;
2) 30 gm of bentonite clay having particle size between 200 to 400 mesh;
3) 2 gm of magnesium stearate;
4) 10 gm of polyvinyl alcohol, and
5) 300 ml of distilled water.

The specification of the tablets is as follows:

TABLE 1
Specification of tablets

Tablets have diameter of 9 mm, 11 mm, 12 mm and 16 mm
Tablets have height of 5 mm

### Example 2: Process of Preparing Silica Gel Desiccant Tablet for Unit Quantities of Silica Gel Desiccant Composition

The process for preparing the silica gel desiccant tablet is described below:
1) 70 g of powdered silica gel having particle size between 200 to 400 mesh is mixed homogeneously with 30 g of bentonite clay having particle size between 200 to 400 mesh, and 2 g of magnesium stearate in a laboratory blender to form a silica gel mixture;
2) 10 g of polyvinyl alcohol is dissolved in 100 ml of distilled water and heated at 60° C. for 1 hour;
3) the polymer solution is cooled at room temperature for about 1.5 hours;
4) the PVA solution is added to the silica gel mixture with continuous stirring;
5) about 200 ml of distilled water is added to the mixture to form a homogenous slurry;
6) the slurry is dried at 110° C. for about 2 hours to obtain a semi dried mixture containing 20% moisture and the mixture is passed through 18 mesh sieves;
7) the dried mixture is pressed in a tablet press with pressure of 15 KN to form tablets; and
8) the tablets are further heated to 110° C. with the ramp rate of 40-70° C. for 1 hour, followed by holding at 70° C. for 30 mins; then at a ramp rate of 70-110° C. for 1 hour and holding at 110° C. for 30 mins.

### Example 3: Moisture Adsorption Capacity of Silica Gel Desiccant Tablet

### 3.1: Method for Determination of Moisture Adsorption Capacity of Silica Gel Desiccant Tablet.

Weight of one silica gel tablet was recorded as M1. The silica gel tablet was then kept in the humidity chamber with the condition of 80% RH & 25° C. The silica gel tablet was removed from the humidity chamber after a specific time interval and the weight reading (M2) was noted down. The process was continued till a constant mass was observed. The weight gain over time was recorded until this reached an equilibrium where two successive consecutive weighing did not differ by more than 3 mg/g of the substance taken. The second weighing was performed following an additional 3±1 hr of storage at the required temperature and humidity conditions.

### 3.2: Formula for Determination of Moisture Adsorption Capacity of Silica Gel Desiccant Tablet.

The below formula was employed to calculate the adsorption capacity as % weight gained over the initial sample weight.

### Calculation:

$$Moisture Adsorption Capacity ( MAC ) \% = [ ( M 2 - M 1 ) / M 1 ] * 100$$

where,
M2=Weight of Silica gel tablet after adsorption
M1=Weight of Silica gel tablet before adsorption

### 3.3: Result of Determination of Moisture Adsorption Capacity of Silica Gel Desiccant Tablet.

The silica gel desiccant tablets showed maximum moisture adsorption capacity of 32% at 25° C. and 80% relative humidity after 24 hours of exposure in confined volume.

### Example 4: Moisture Adsorption Capacity Based on the Dimensions of the Tablets

Different dimensions (9×5 mm, 11×5 mm, 12×5 mm and 16×5 mm) of tablets were prepared to observe the effect of increasing diameter towards moisture adsorption capacity of tablets.

TABLE 2
Moisture adsorption capacity of the Tablets

| Tablet no. | Diameter | | Height | MAC at 80% RH & 25° C. |
|---|---|---|---|---|
| 1 | 9 | mm | 5 mm | 22.0% |
| 2 | 11 | mm | 5 mm | 21.8% |
| 3 | 12 | mm | 5 mm | 22.2% |
| 4 | 16 | mm | 5 mm | 22.8% |

The end results suggested that not much difference in the moisture adsorption performance of the tablet composition is observed. The specific percentage weight gain was directly proportional to the quantity of tablet content under observation.

These and other embodiments will be apparent to those of skill in the art and others in view of the following detailed description of some embodiments. It should be understood, however, that this summary, and the detailed description illustrate only some examples of various embodiments, and are not intended to be limiting to the invention as claimed.

The silica gel desiccant tablet of the present invention does not require to be embedded in a polymeric material to form a shaped tablet. Further the silica gel desiccant tablet does not require high temperature treatment for synthesis. The tablets are obtained in a mechanically stable form without compromising the moisture adsorption performance. The tablets with various dimensions can be prepared as per the required adsorption performance. The silica gel desiccant tablets show maximum moisture adsorption capacity of 22.8% at 25° C. and 80% relative humidity. It is the moisture adsorption capacity contributed by 70% of silica gel content in each tablet. Accordingly, the silica gel content and eventually the weight of tablets can be increased to prepare tablets equivalent to 100% silica gel granules being used conventionally.

The embodiments were chosen and described in order to best explain the principles of the present invention and its practical application, to thereby enable others, skilled in the art to best utilize the present invention and various embodiments with various modifications as are suited to the particular use contemplated.

It is understood that various omission and substitutions of equivalents are contemplated as circumstance may suggest or render expedient, but such are intended to cover the application or implementation without departing from the spirit or scope of the present invention.

1. A silica gel desiccant tablet comprising:
a) 60 to 65% silica gel powder having a particle size between 200 to 400 mesh;
b) 25 to 30% powdered bentonite clay having a particle size between 200 to 400 mesh;
c) 1.5 to 2% magnesium stearate;
d) 5 to 10% water soluble polymer; and
e) 200 ml distilled water.

2. The silica gel desiccant tablet as claimed in claim 1 including:
a) 70 gm of powdered silica gel having particle size between 200 to 400 mesh;
b) 30 gm of bentonite clay having a particle size between 200 to 400 mesh;
c) 2 gm of magnesium stearate;
d) 10 gm of polyvinyl alcohol, and
e) 300 ml of distilled water.

3. A process for preparation of silica gel desiccant tablet as claimed in claim 1 including the steps of:
a) mixing 60 to 65% of silica gel powder having particle size between 200 to 400 mesh thoroughly with 25 to 30% of powdered bentonite clay having a particle size between 200 to 400 mesh, and 1.5 to 2% of magnesium stearate to form a silica gel mixture;
b) dissolving 5 to 10% of water-soluble polymer in 200 ml of distilled water and heating at first predefined temperature for a first predefined time;
c) cooling the polymer solution to a second predefined temperature for a second predefined time;
d) mixing the polymer solution to the above silica gel mixture under constant stirring;
e) adding 200 ml of distilled water to the mixture to form a homogenous slurry;
f) drying the slurry at a third predefined temperature at a third predefined time to obtain a dried mixture containing 20% moisture;
g) pressing the dried mixture at a predefined pressure to form tablets; and
h) further heating the tablets to remove remaining moisture.

4. The process of preparation of silica gel desiccant tablet as claimed in claim 3 wherein:
a) the water-soluble polymer is dissolved in 200 ml of distilled water and heated at 60° C. for 1 hour;
b) the polymer solution is cooled to room temperature for 1.5 hours;
c) the slurry is dried at 110° C. for 2 hours to obtain a dried mixture containing 20% moisture; and
d) the dried mixture is pressed at a pressure between 12 to 17 KN to form tablets.

5. The process for preparation of silica gel desiccant tablet as claimed in claim 3 for unit quantities of silica gel desiccant composition including the steps of:
a) mixing 70 g of powdered silica gel having particle size between 200 to 400 mesh homogeneously with 30 g of bentonite clay having a particle size between 200 to 400 mesh, and 2 g of magnesium stearate in a laboratory blender to form a silica gel mixture;
b) dissolving 10 g of polyvinyl alcohol in 100 ml of distilled water and heating at 60° C. for 1 hour;
c) cooling the polymer solution at room temperature for 1.5 hours;
d) adding the PVA solution to the silica gel mixture with continuous stirring;
e) adding 200 ml of distilled water to the mixture to form a homogenous slurry;
f) drying the slurry at 110° C. for 2 hours to obtain a semi dried mixture containing 20% moisture and passing the mixture through 18 mesh sieves;
g) pressing the dried mixture in a tablet press with pressure of 15 KN to form tablets; and
h) heating the tablets further to 110° C. with the ramp rate of 40-70° C. for 1 hour, followed by holding at 70° C. for 30 mins; then at a ramp rate of 70-110° C. for 1 hour and holding at 110° C. for 30 mins.

6. The silica gel desiccant tablets as claimed in claim 1 having maximum moisture adsorption capacity of 22.8% at 25° C. and 80% relative humidity after 24 hours of exposure in confined volume.
